(19) United States
(12) Patent Application Publication
(10) Pub. No.: US 2005/0287040 A1
(43) Pub. Date: Dec. 29, 2005

(54) Fluorescence validation plate

(75) Inventors: Robert H. Giebeler, San Francisco, CA (US); Evelyn L. McGown, Hillsborough, CA (US); Jonathan F. Petersen, Redwood City, CA (US); Todd E. French, Sunnyvale, CA (US)

Correspondence Address: DORSEY & WHITNEY LLP, 555 CALIFORNIA STREET, SUITE 1000, SUITE 1000, SAN FRANCISCO, CA, 94104, US

(73) Assignee: Molecular Devices Corporation

(21) Appl. No.: 10/879,625

(22) Filed: Jun. 29, 2004

(51) Int. Cl. B01L 3/00; G01N 21/66

(52) U.S. Cl. 422/82.08; 422/102

(57) ABSTRACT

Fluorescence validation material comprising first layer and a second layer that is useful as validation and calibration standards as well as validation plates including one or more fluorescence validation materials. Moreover, this invention includes methods for using validation plates and fluorescence validation materials of this invention to validate and calibrate instruments.

### BACKGROUND OF THE INVENTION

(1) Field of the Invention

This invention is directed to fluorescence validation materials that are useful as validation and calibration standards. This invention also includes a validation plate including at least one fluorescence validation material. Moreover, this invention includes methods for using validation plates and fluorescence validation materials of this invention to validate and calibrate instruments.

(2) Description of the Art

There are a number of instruments that use light in one manner or another to detect, for example, the presence or absence in a solution or solid of an ingredient, a compound, a biological material, a reaction product, a test result and/or to measure the degree to which such a component is present in a sample. Certain such instruments operate by absorbance wherein a beam of light is passed through a sample and the wavelength and/or intensity of the beam is monitored by a detector. Other such instruments operate by luminescence wherein any light emitted from the sample is monitored by a detector. Examples of such luminescence instruments are luminometers, fluorometers, spectrofluorometers fluorescence polarimeters or fluorescence spectropolarimeters. Several embodiments of which are described generally in U.S. Pat. Nos. 5,355,215, 6,071,748, and 6,232,608, and U.S. patent application Ser. No. 10/061,416, filed Feb. 1, 2002, the specifications of which are incorporated herein by reference.

Luminescence is the emission of light from excited electronic states of luminescent atoms or molecules. Luminescence generally refers to all kinds of light emission, except incandescence, and may include photoluminescence, chemiluminescence, and electrochemiluminescence, among others. In photoluminescence, including fluorescence and phosphorescence, the excited electronic state is created by the absorption of electromagnetic radiation. Fluorescence and phosphorescence essentially differ only in the particular excited state that luminesces and the terms are used interchangeably within this application. In chemiluminescence, which includes bioluminescence, the excited electronic state is created by a transfer of chemical energy. In electrochemiluminescence, the excited electronic state is created by an electrochemical process. Luminescence is used in a variety of assays and testing procedures such as luminescence intensity assays and luminescence polarization assays.

Intensity Assays

Luminescence intensity assays involve monitoring the intensity (or amount) of light emitted from a composition. The intensity of emitted light will depend on the extinction coefficient, quantum yield, and number of luminophores in the composition, among others. These quantities, in turn, will depend on the environment of the luminophore, including the proximity and efficacy of quenchers and energy transfer partners. Thus, luminescence intensity assays may be used to study binding reactions, among other applications.

Polarization Assays

Photoluminescence polarization assays involve monitoring the intensity of polarized light emitted from a composition. Polarization describes the direction of light's electric field, which is perpendicular to the direction of light's propagation. Photoluminescence polarization assays may be homogeneous and ratiometric, making them relatively insensitive to sample-to-sample variations in concentration, volume, and meniscus shape.

Photoluminescence polarization assays typically are used to study molecular rotation. FIG. 1 shows how luminescence polarization is affected by molecular rotation. In a luminescence polarization assay, specific molecules 61, 62, 63, 64 within a composition 66 are luminescent (e.g., labeled with one or more luminophores). The composition is illuminated with polarized excitation light, which preferentially excites luminophores having absorption dipoles aligned parallel to the polarization of the excitation light. In FIG. 1 excitation polarization is in the vertical direction causing vertically aligned molecules 61, 63 (shaded) to be excited. Molecules 62, 64 (unshaded) not substantially aligned with the polarization direction have a low probability of excitation. The excited molecules subsequently emit light preferentially polarized parallel to their emission dipoles. The extent of polarization of the total emitted light depends on the extent of molecular reorientation during the time interval between luminescence excitation and emission, which is termed the luminescence lifetime. In turn, the extent of molecular reorientation depends on the luminescence lifetime and the size, shape, and environment of the reorienting molecule. In particular, molecules commonly rotate or tumble via diffusion with a rotational correlation time that is proportional to their size. Thus, during their luminescence lifetime, relatively large molecules, and small molecules 61 bound to large ones, will not reorient significantly, so that their total luminescence will be relatively polarized. In contrast, during the same time interval, relatively small molecules 63 will reorient significantly, essentially randomizing the orientation, so that their total luminescence will be relatively unpolarized. Thus luminescence polarization assays can be used to quantify molecular size changes that occur for example in binding or hybridization reactions.

The relationship between polarization and intensity is expressed by the following equation:

$$P = \frac{{I}_{∥} - {I}_{⊥}}{{I}_{∥} + {I}_{⊥}} \qquad ( 1 )$$

Here, P is the polarization, I_{∥} is the intensity of luminescence polarized parallel to the polarization of the excitation light, and I_{⊥} is the intensity of luminescence polarized perpendicular to the polarization of the excitation light. P generally varies from zero to one-half for randomly oriented molecules (and zero to one for aligned molecules). If there is little rotation between excitation and emission as is the case with large or bound molecules, I_{∥} will be relatively large, I_{⊥} will be relatively small, and P will be close to one-half. In contrast, if there is significant rotation between absorption and emission as is the case with small, unbound molecules, I_{∥} will be comparable to I_{⊥}, and P will be close to zero. Polarization often is reported in milli-P (mP) units (1000×P), which for randomly oriented molecules will generally range between 0 and 500, because P will generally range between zero and one-half.

Polarization also may be described using other equivalent quantities, such as anisotropy. The relationship between anisotropy and intensity is expressed by the following equation:

$$r = \frac{{I}_{∥} - {I}_{⊥}}{{I}_{∥} + 2 {I}_{⊥}} \qquad ( 2 )$$

Here, r is the anisotropy. Polarization and anisotropy include the same information, although anisotropy yields simpler mathematical expressions for systems containing more than one luminophore. In the description and claims that follow, these terms may be used interchangeably, and a generic reference to one should be understood to imply a generic reference to the other.
Microwell Plate Reader Validation and Calibration

Fluorometers have been designed for use in analyzing samples held in wells in plates that have a multitude of sample containing wells—such as an 8×12 microwell plate. It is important for the proper functioning of these instruments that the measurement of samples in each well is accurate and reproducible regardless of the position of the well in the plate array and regardless of the number of samples that have been analyzed by the instrument. Therefore, users of such instruments require methods and devices that verify the performance of the instruments (validation) and/or allow for the adjustment of such instruments to bring them back into proper performance (calibration).

Calibration and validation are required to ensure the analysis results reported by the instrument are reproducible over time. Moreover, calibration can correct systemic instrument errors so that results can be compared across different instruments and/or laboratories. Additionally, calibration can allow conversion of the raw measured signals into absolute calibrated measurements. Finally, the calibration can correct position dependent errors in microwell plate readers.

Instrument calibrations can typically be categorized into three classes. Those are: (1) calibrations that correct spectral measurements; (2) calibrations that correct for intensity measurements; and (3) calibrations that correct for polarization measurements. The prior art discloses methods, apparatus and compositions that are useful as calibration standards or that are useful in calibrating instruments such as fluorometers. U.S. Patent Application Publication Number 2002/0048817, for example discloses a composition and process for fabrication of absorptive and fluorescent standards in cuvettes and microwell plates. Similarly, U.S. Pat. No. 6,348,695 and U.S. Patent Application Publication Number 2003/0012702 disclose solid state devices for the calibration of microwell plate spectrometers. Such chemical and solid state standards suffer from problems such as temperature sensitivity, ease of use, and scope of use. In particular none of the prior art disclose wavelength or polarization calibration devices for microwell plate spectrometers. For intensity calibration U.S. Patent Application Publication Number 2003/0012702 discloses wells of decreasing diameter which are unsuitable for microwell plate readers intended to read a standard dimension microwell.

Calibration standards and devices are typically not capable of being used to simultaneously check accuracy and precision for more than one intensity, wavelength and polarization. Therefore, there remains a need for calibration materials, apparatuses, and methods that provide more precise instrument validations and calibrations and that allow for the simultaneous calibration of more than one of intensity, wavelength and polarization.

### SUMMARY OF THE INVENTION

One aspect of this invention is a fluorescence validation material comprising: a first layer selected from a fluorescent layer or a reflective layer; and a second light attenuating layer selected from a continuous attenuating layer or a quasi-continuous attenuating layer.

Another aspect of this invention is a microwell plate comprising a plurality of wells wherein at least two wells include different fluorescence validation materials and wherein the fluorescence validation materials are selected from: an intensity validation material; a wavelength validation material; and a polarization validation material.

Yet another aspect of this invention is a microwell validation plate comprising: a carrier having a plurality of wells arranged in an array including at least one row of wells and at least one column of wells; and at least two wells that include different fluorescence validation materials wherein the validation material comprises a first layer that is a fluorescent or reflective layer and a second light attenuating layer that is a continuous layer or a quasi-continuous layer and wherein the validation material is selected from: (i) an intensity validation material including a first layer of fluorescent or reflective material and a second light attenuating layer that is spectrally neutral and polarization neutral; (ii) a wavelength validation material including a first layer of fluorescent or reflective material and a second light attenuating layer that is spectrally selective and polarization neutral; and (iii) a polarization validation material including a first layer of fluorescent or reflective material and a second light attenuating layer that is spectrally neutral and polarization selective.

Still another aspect of this invention is a microwell validation plate comprising a carrier having a plurality of wells arranged in an array of a plurality of rows and a plurality of columns wherein at least one column includes a well associated with a standard intensity validation material, at least one column includes a well associated with a first different intensity validation material, at least one column includes a well associated with a second different intensity validation material, at least one column includes a well that is associated with a third different intensity validation material, at least one column includes a well associated with a first wavelength validation material, and at least one column includes a well associated with a second wavelength validation material.

Yet another aspect of this invention is methods for validating and calibrating an instrument. The methods include the steps of: preparing a validation plate comprising a carrier having a plurality of wells arranged in an array including at least one row of wells and at least one column of wells wherein at least one well contains a fluorescence validation material selected from an intensity validation material, a polarization validation material, and a wavelength validation material wherein the fluorescence validation material emits light having at least one feature having a known value when an excitation source is directed at the validation plate; placing the validation plate in an instrument that includes a excitation source and a detector; directing the excitation source at the validation plate; detecting a value for the at least one feature of the light being emitted from at least one well; and comparing the detected value of the light feature emitted from the at least one well with the known value of the light feature.

### DESCRIPTION OF THE FIGURES

FIG. 1 depicts principles of fluorescence polarization of molecules;

FIGS. 2A and 2B are cross-sections of embodiments of a fluorescence validation material of this invention;

FIG. 3 is an overhead view of an embodiment of a fluorescence validation plate structure of this invention;

FIG. 4 is a side-cutaway view along line A (column 8) of the fluorescence validation plate embodiment of FIG. 3;

FIG. 5 is a side-cutaway view along line B of the fluorescence validation plate embodiment of FIG. 3; and

FIG. 6 is an exploded view of a fluorescence validation plate embodiment of this invention.

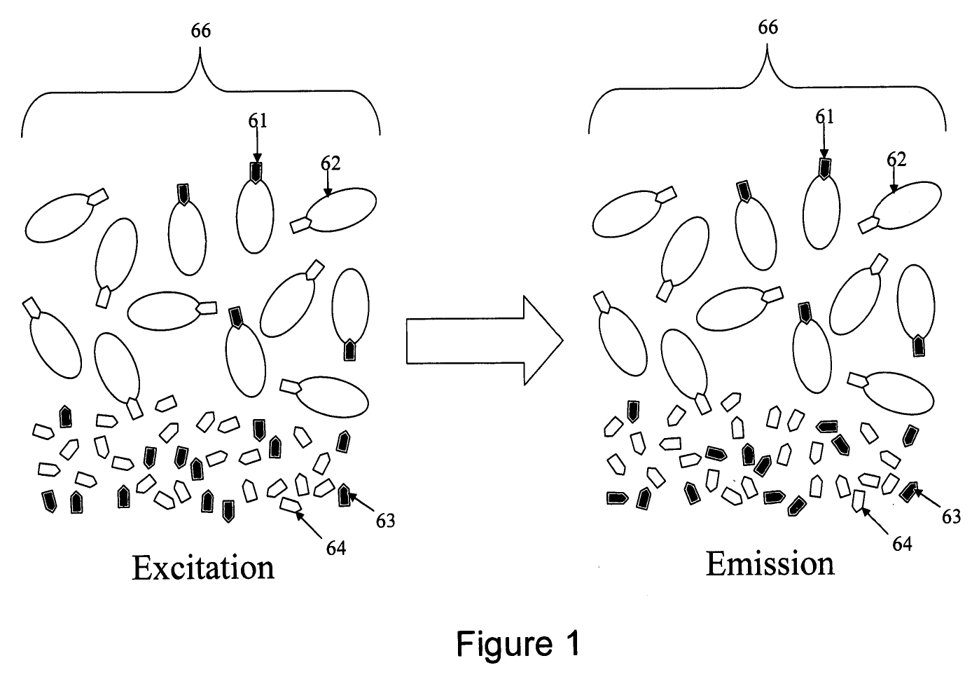

### DESCRIPTION OF THE CURRENT EMBODIMENT

One aspect of this invention is a fluorescence validation material that is useful as a validation or a calibration standard. This invention also includes fluorescence validation plates that are useful for validating and/or calibrating analytical instruments. Moreover, this invention includes methods for using fluorescence validation plates for wavelength and/or emission intensity and/or polarization validation and calibration.

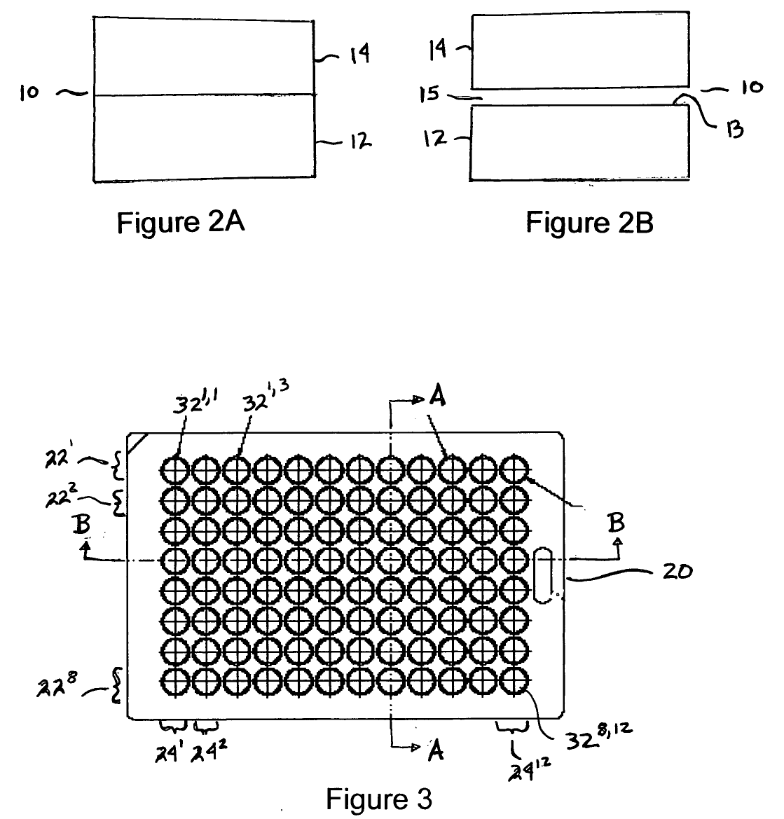

In one embodiment, this invention is a fluorescence validation material that is useful as a fluorescence intensity and/or wavelength and/or polarization standard. An embodiment of a fluorescence validation material is shown in FIGS. 2A and 2B. The fluorescence validation material 10 of FIG. 2 comprises a first layer 12 and a second light attenuating layer 14. Generally the function of the first layer 12 is to emit light when illuminated. The function of the second light attenuating layer 14 is to modify the emitted light either by modifying the illumination, the first layer emission or both.

The first and second layers may be irreversibly united with one another using, for example, an adhesive material or by coating one material with the other as shown in FIG. 2A. Alternatively, second layer 14 may be placed on top of a surface 13 of first layer 12 in removable manner. In yet in further alternative embodiment, second layer 14 may be placed a small distance away from top surface 13 of first layer 12 to form a gap 15 between first layer 12 and second layer 14 as shown in FIG. 2B.

In one embodiment, first layer 12 is a fluorescent material, preferably a stable fluorescent material, and more preferably a stable fluorescent polymer material. The term “polymer” is used very broadly herein to refer to any polymeric and/or resin material that forms a solid. Non-limiting examples of such useful polymers include acrylic materials, phenoxy polymer materials, polycarbonate materials, polyvinyl chloride materials and combinations thereof, with acrylic and acrylic containing materials being preferred.

Examples of useful fluorescent acrylic materials are manufactured by Cyro Industries (Acrylite GP-F, Acrylite GP-FLW), Atofina Chemicals (Altuglas CN fluorescent, Altuglas CN fluolux, Plexiglas GS), Lucite International (Lucite, Perspex), Plastiglas de Mexico (Chemcast), and Polycast Corp. (Polycast) amongst others. These materials and ones substantially similar come in a variety of colors and are generally highly photostable. Preferred acrylic stable materials are green fluorescent and transparent.

Other stable fluorescent materials useful for fabricating first layer 12 include, but are not limited to, inorganic or organic solids such as glasses and crystals (intrinsically fluorescent or doped with fluorescent organic or inorganic molecules or ions), and fluorescent liquids and gases (typically sealed in an ampoule to prevent environmental degradation). Transparent materials are preferred but opaque materials can be used if the surface fluorescence is great enough.

The stable fluorescent material of first layer 12 should provide a desired and/or reproducible fluorescence emission intensity when the material is excited by the appropriate light. The amount and type of fluorescent material used may vary depending upon the intensity of the light used in the instrument being calibrated, the intensity of the desired fluorescence of first layer 12, as well as the sensitivity of the detector being calibrated.

Whatever first material layer 12 is used, it must be stable to serve as part of fluorescence validation material 10. Stability is assessable in many different ways. Generally the fluorescent material must be capable of delivering the same amount and type (intensity, wavelength, and polarization) of fluorescence when probed with the same general conditions. The stable fluorescent material is preferably photostable, that is, capable of being exposed to excitation light for a long time without degradation. In addition, the material is preferably environmentally stable, able to withstand common environment factors such as humidity, temperature cycles, and aging without significant change to the fluorescence properties. The material should maintain the same fluorescence properties for at least several days of use, preferably for one year or more and should be stable for a comparable period of storage. Further, the material is preferably temperature stable, its fluorescence properties insensitive to temperature within the operating range the fluorescence reader to be validated.

Many solid fluorescent materials may be used without modification as a polarization standard. Generally fluorophores emit polarized light and when embedded in a solid matrix exhibit a stable fluorescence polarization value. That is, they emit substantially uniform and reproducible polarized light. If a fluorescent material is used as the first layer it is preferred that it has either a high or low polarization.

In another embodiment the first layer 12 is a reflective layer. When excitation light impinges upon a fluorescent layer it transforms the light and emits a different color. A reflective layer of material redirects the excitation light. In a fluorometer, the detection system is generally arranged such that it receives very little, if any, excitation light. This arrangement is necessary because typical fluorescence emission is weak compared to the excitation light. For such a system the detector is not capable of measuring the full excitation intensity. The reflective layer then must redirect the excitation light to the detector without saturating it. One way to reflect the excitation light is with a scattering (diffuse reflective) surface such as one that has been frosted, buffed, lapped, ruled, scratched or roughened. Scattering materials may also be media with suspended particles of high or low index of refraction, opal glass and the like. Diffuse reflection has the additional benefit that the reflected light generally has a spatial distribution similar to that of fluorescence emission (i.e., in all directions). Alternatively a specular reflective surface may be used to reflect the excitation light to the detector. This approach has the disadvantage of being capable of directing too much excitation light but the reflected light may be attenuated by the second light attenuating layer 14 as described further below. Specular reflective surfaces are generally smooth or polished, coated with reflective materials such as metal or dielectric films.

First material layer may alternatively be selected from any material that is uniformly or essentially uniformly luminescent. Examples of such layers include, but should not be limited to chemiluminescent, electrochemiluminescent, electroluminescent, fluorescent, phosphorescent, scintillant material layers, and any combinations thereof.

Second light attenuating layer 14 modifies the light emitted from first layer 12 through attenuation in some manner. Second light attenuating layer 14 is preferably selected from the group of layers including a continuous attenuating layer, a quasi-continuous attenuating layer or a combination of such layers, wherein the attenuation may be spectrally selective or neutral and/or polarization selective or neutral. The term “continuous” is used herein to refer to a material that can be considered uniform at the size scale of the interrogating light beam.

Useful continuous attenuating layers and quasi-continuous layers may be selected from compounds and/or materials that have substantially no fluorescence. One function of second light attenuating layer 14 is to reduce the apparent intensity of the light emitted from first layer 12 by reducing the light excitation, emission, or both. Examples of useful continuous attenuating layers include materials used to create neutral, spectrally, or polarization selective optical filters such as neutral density filter glass (e.g. Schott NG series glass), colored filter glass (e.g. Schott RG, OG, GG, BG, WG, KG and UG series glass), spectrophotometer wavelength calibration materials (e.g., holmium glass or solution, didymium glass, benzene solution or vapor, potassium dichromate solution), rare earth metal doped glass, etalons, polarizing filters, dichroic polarizers, opal glass, thin reflecting and/or absorbing films such as metal (e.g. Al, Ag, Au), metal alloys (e.g. Inconel) or dielectric films, and combinations of any or all of the above examples. One group of spectrally selective materials include metal—doped glasses, dielectric films, etalons, inks, colored glass and combinations thereof. Preferred metal—doped glasses include glasses doped with a rare earth metal selected from the group Holmium, Neodymium, Praseodymium, Samarium, and combinations thereof.

Especially in the case of films or thin attenuating materials, second light attenuating layer 14 may comprise a solid support to which a layer of continuous attenuating material or a quasi-continuous attenuating material has been applied to form a composite second layer 14. In one example, second light attenuating layer 14 may comprise a transparent glass or plastic material that is coated with a layer of continuous attenuating material, quasi-continuous attenuating material layer or a combination of such layers. Alternatively the second light attenuating layer 14 may be the film or thin layer which is applied to the first layer 12 without any further solid support.

Second light attenuating layer 14 may be a quasi-continuous attenuating layer. Quasi-continuous attenuating layers are distinguished from continuous attenuating layers in that they consist of at least two regions, one that is substantially transmissive and one that is substantially opaque. The characteristic size of these regions must be smaller than the light beam used to excite fluorescence so that the light beam impinges upon both regions. Ideally there are multiple opaque and transmissive regions and the light beam impinges upon more than one opaque and more than one transmissive region. For example if the beam size is 1 mm the characteristic size of the regions should be less than about 0.5 mm. The substantially opaque regions need only to be opaque to certain wavelengths or polarization states of light but preferable embodiments are opaque to all wavelengths and polarization states of light. Examples of useful quasi-continuous attenuating layers include, but are not limited to, micro-patterned layers such as a fine wire meshes, absorbing inks, reflective inks, metals and so forth. A quasi-continuous layer 14 may be, for example, ink or another material that is applied to a surface of the first layer 12 or to the surface of a solid support by a variety of methods, such as lithography, contact printing, ink jet printing, or silk screening. Note that the word pattern should not be interpreted as limiting such designs to a uniform or regular pattern (such as halftone). A random pattern that occludes the appropriate fraction of the beam is just as useful.

The second layer may be a polarization attenuating layer that alters the polarization of the light that excites and/or is emitted by the first layer. The polarization attenuating layer may be selected from surfaces or materials that scatter (depolarize) the light emitted by the first layer, that select just one polarization state of the emitted light, or that cause the light emitted by the first material layer to be partially polarized (contains more than one polarization state). Examples of polarization attenuating materials include, but are not limited to dichroic polarizers, linear polarizers, beamsplitting polarizers, circular polarizers, polarization retarders (waveplates), refractive polarizers, polarization scramblers, depolarizers, and optical diffusers.

The advantage of using a second light attenuating layer 14 along with first layer 12 is that the function of the fluorescence validation material 10 can be modified simply by varying the character, amount, thickness and so forth of second light attenuating layer 14. In a multifunctional fluorescence validation plate, all wells may make use of the same fluorescent material (first layer 12) with wells requiring different functions using different second material layers. Generally fluorescent and reflective materials are available (as listed above) but are not suitable for fluorescence validation purposes because the emitted light properties (e.g., intensity, spectra, and polarization state) are not precisely controlled or, for intensity specifically, is too bright, out of range of the detector. These materials become suitable for fluorescence validation purposes with the addition of suitable, precise, optical validation materials (the second light attenuating layer 14). For example with the present invention there is no need to devise a way to create a series of fluorescent materials with differing intensities. The present invention can establish a range of reproducible fluorescence intensities through the use of a single fluorescent material as first layers 12 and a range of optical attenuators (e.g., neutral density filters) as second light attenuating layers 14.

The fluorescence validation materials of this invention, as described above with reference to FIGS. 2A-2B, are useful for calibrating instruments, such as instruments that measure fluorescence. Therefore, the fluorescence validation materials of this invention can be formed into any shape that is useful for calibrating a particular instrument. Typically the fluorescence validation material will be formed into the shape of or placed in receptacles that hold the samples analyzed by the instrument. For example, the fluorescence validation materials of this invention may take on the shape of a cuvette, they may be loaded into a microwell plate, or they can be formed in any shape that will allow them to be useful as a calibration standards. The fluorescence materials may be embedded inside an instrument where they can be evaluated periodically or continuously.

Another aspect of this invention is microwell validation plates having one or more wells that include fluorescence validation materials. The number of wells in a microwell plate will vary widely. Such plates can include tens, hundreds, and even thousands of wells (6, 24, 96, 384 and 1536 wells being the most common formats). Microwell plates 20 typically have the structure shown in FIG. 3 and include a plurality of rows 22 of wells 32 and a plurality of columns 24 of wells 32. Microwell plate 20 shown in FIG. 3 includes 12 rows and 8 columns that define a total of 96 wells. Rows 22 are numbered from top to bottom with the top most row of FIG. 3—the first row—designated by numeral 22¹. The next row is the second row and it is designated by numeral 22² in FIG. 3. The bottom-most row—the eighth row—is designated in FIG. 3 by numeral 22⁸. Likewise, columns 24 are numbered from left to right with the left-most column 24 being designated by numeral 24¹. The next adjacent column is designated by numeral 24¹² and the twelfth column—the right-most column is designated by numeral 24¹². Wells 32 are likewise numbered using these designations with the top left most well 32 being designated (1,1) and the lower right hand most well 32 being designated as (8,12). For purposes of this invention, the terms “row” and “column” can be reversed. The rows designated by numeral 22 maybe called columns in which case the columns designated by numeral 24 would be called rows.

The microwell validation plates of this invention will include at least one row 22 and one column 24 of wells 32. Moreover, there is no limit on the maximum number of columns or rows or wells that the microwell validation plate of this invention may include. The upper limit is set by the requirements of the instruments being validated or calibrated.

A 96 well plate (12 columns×8 rows) such as the plate shown in FIG. 3 will be used to discuss some preferred aspects of the validation plates of this invention. However, this invention is not limited to any particular microwell validation plate configuration and the application of this invention to microwell plates with more or fewer than 96 wells as well as to plates including cuvettes or other sampling chambers or methods is well within the knowledge of one having ordinary skill in the art.

The validation plates of this invention are useful for validating and/or calibrating one or more of the following: (1) the accuracy and precision of intensity measurement; (2) the linearity of intensity measurement; (3) instrument bias in the measurement of intensity, wavelength or polarization validation materials located in different wells in a microwell validation plate; (4) the accuracy and precision of wavelength measurement; and (5) the accuracy and precision of polarization measurement. In order to make one or more of these measurements, the validation plates of this invention will preferably be constructed so that they are capable of evaluating an instrument's ability to make at least two and preferably three to all five types of the above identified validation calibration measurements.

Validation plates of this invention will typically comprise at least one well that includes a fluorescence validation material selected from an intensity validation material, a wavelength validation material, and a polarization validation material. Alternatively, a preferred validation plate of this invention will include at least one well that includes one of the three types of validation materials mentioned above and a second well that includes another of the two remaining types of validation materials mentioned above. In another preferred embodiment, the validation of this invention will include at least one well that includes an intensity validation material, at least one well that includes a wavelength validation material, and at least one well that contains a polarization validation material. Moreover, to evaluate the ability of an instrument to measure varying intensities, two or more wells may include different intensity validation materials. The term “different intensity validation materials” is used herein to refer to validation materials that emit light at different known intensities when excited in known conditions. Generally “different validation materials” refer to materials that are measurably different in a properly functioning test instrument. Intensity validation materials may be used to establish intensity accuracy, precision and/or linearity. The wavelength validation material may be used to establish wavelength accuracy, precision and/or spectral bandwidth. The polarization validation material may be used to establish polarization accuracy and/or precision.

It is also useful to include validation materials having essentially the same validation material in at least two and preferably a plurality of wells in a validation plate. The term “essentially the same validation materials” refer to validation materials that have the same emitted light properties—they are not measurably distinct in a properly functioning test instrument. For example, the intensity should not vary more than about 10% from well to well, preferably not more than 1%, for use in an instrument capable of 10% precision. The allowable range is dependent on the desired precision of the test instrument.

Wells including essentially the same intensity validation materials can be arranged in an array in several ways to facilitate different calibrations. Instrument measurement bias can be verified and/or ruled out by placing essentially the same intensity validation materials in one or more wells at peripheral locations on the validation plate such as the corner wells, near the corner wells, the top and bottom rows, left and right columns or dispersing the essentially the same intensity validation materials in wells throughout the validation plate. Bias is evaluated by evaluating the instrument's ability to measure the intensity of wells including essentially the same intensity validation materials. Large deviations from the expected intensity value can be an indication of instrument bias. Instrument bias may be evaluated similarly when measured for wavelength or polarization.

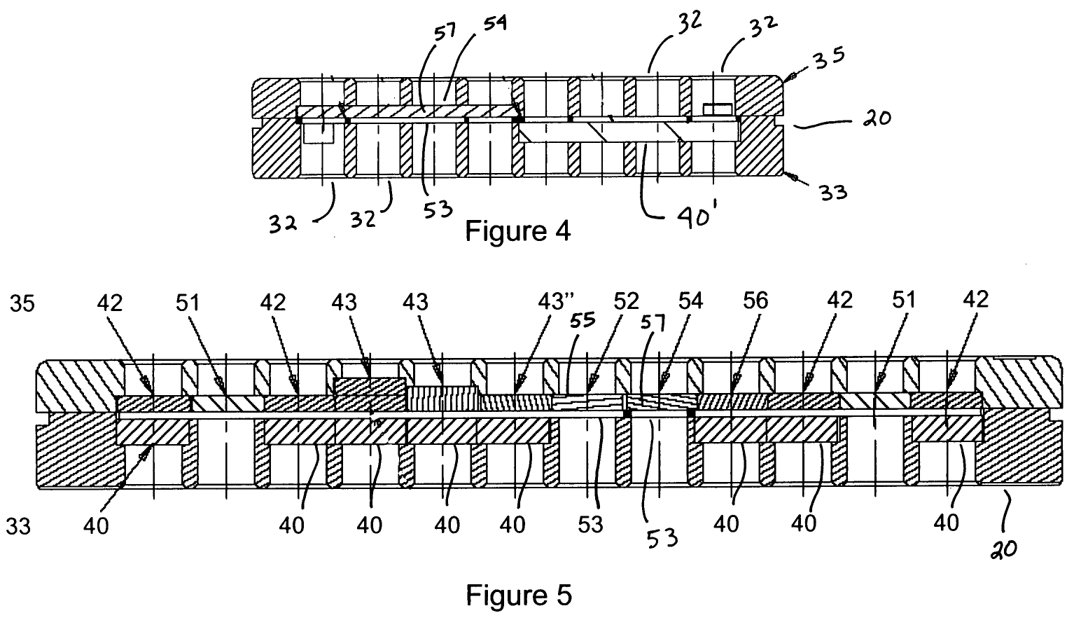

FIGS. 4 and 5 are side and front cut away views along lines A and B respectively of the embodiment of the microwell validation plate 20 of FIG. 3. FIGS. 3, 4, and 5 represent a microwell plate 20 having an array of wells 32. The array of wells 32 are arranged in a series of rows 22 and columns 24 to form an array of 96 wells. Microwell validation plate 20 further includes a base 33 and a cover 35. Depending on the configuration of the material, the base 33 or cover 35 may be omitted. For example if the second light attenuating layer 14 is a printed film located on first layer 12, the boundaries of the print can indicate the edge of the wells (e.g. printing only attenuating layers in the regions of wells, leaving the rest blank or printing an opaque layer outside the regions of the wells). For the base 33, if the fluorescent layers are bound together as a single piece they may be formed to the shape of the instrument sample holder (e.g., a microwell plate form). Additionally base 33 may have holes under the wells as depicted in the figures or it may have opaque material under the wells. Holes under the wells ensure that the validation plate does not contribute any additional fluorescence and simulates clear bottom microwell plates that are compatible with most fluorescence microwell plate readers. Using opaque materials allows the validation plate to stop the light flow out of the bottom of the microwell plate for those instruments not designed for clear bottom plates.

Microwell validation plate 20 may include one or more fluorescence validation materials each located in or positioned relative to a discrete well 32. No more than one fluorescence validation material should be located in a single discrete well 32. The selection of fluorescence validation material associated with a well will depend upon the desired validation/calibration. Microwell validation plate 20 can be manufactured so that every well 32 holds the same fluorescent validation material. Alternatively, microwell validation plate 20 can be manufactured so that different combinations of wells hold different fluorescence validation materials. The advantage of a microwell validation plate 20 having two or more different fluorescence validation materials is that a single validation plate can then be used to evaluate the ability of an instrument to measure a range of emission intensities, wavelengths, polarizations and combinations thereof—a single plate can meet all validation and calibration needs.

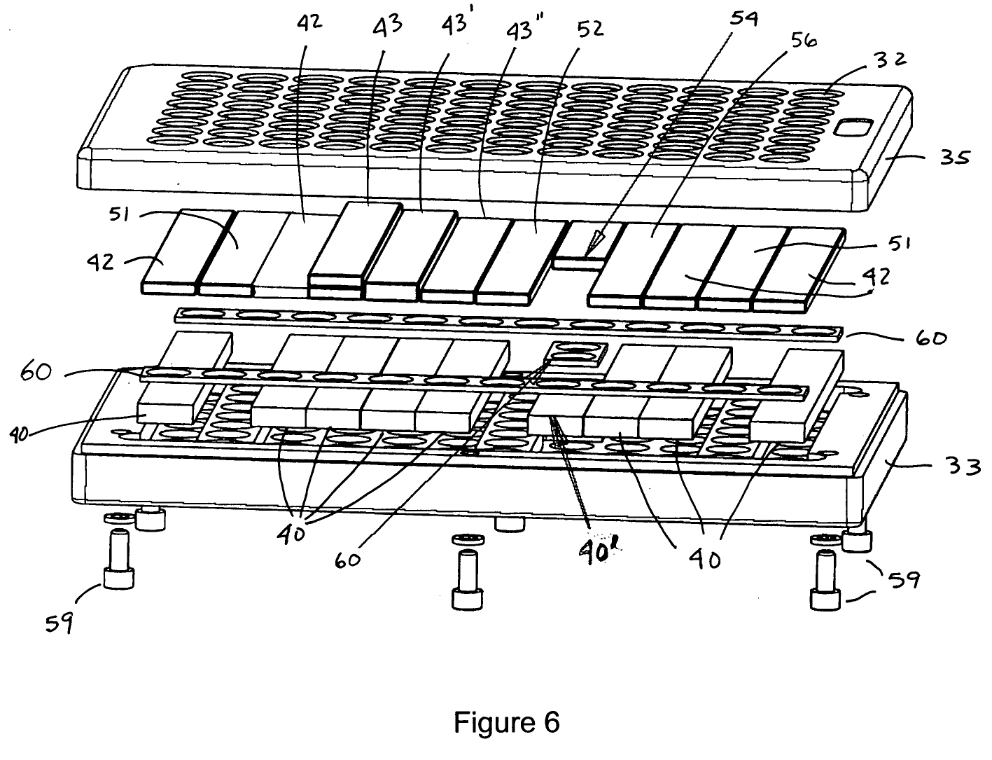

FIG. 6 is an exploded view of a validation plate embodiment of this invention. In FIG. 6, the plate includes a base 33 and a cover 35 each including a plurality of complementary apertures, where each aperture defines a well 32. The apertures are the full dimension of a standard microwell and do not reduce the excitation or emission light in any way. Moreover, validation plate 20 includes a plurality of first layers in the form of strips 40. Strips 40 may run the entire length of a column or strips 40 may cover only several wells of the column as shown with strip 40′. Second layer strips of light attenuating material 42, 43, 52, 54, 56 are placed, where appropriate on top of the first layer strips. As with the first layer strips 40, the second layer strips may cover all of the wells of a column or they may cover less than all of the wells in a column as demonstrated by second layer strip 54. Two parallel gaskets 60 are placed on top of the first layer strips and separate first layer strips from second layer strips. Base 33 is united with cover 35 with screws 59.

Intensity Validation Materials

FIGS. 4 and 5 are cross sections of one preferred microwell validation plate 20 of this invention. In FIG. 5, each well in columns 1, 3, 10 and 12 (numbered from left to right in the Figure) include the same first layer, strip 40, having a known intensity. A continuous attenuating layer 42 in the form of a neutral density glass filter lies on top of each first layer 40 in columns 1, 3, 10 and 12. On top refers to the direction within the drawing. The attenuating layer must be placed along the optical excitation path before the first layer or in the optical emission path after the first layer or both (as in this case). For example if the microwell plate reader reads fluorescence from the bottom rather than the top the attenuating layer would be placed below the first layer. The combination of first layer 40 and continuous attenuating layer 42 forms a “standard” intensity validation material. Associating the same first layer 40 and the same continuous attenuating layer 42 with each well 32 of columns 1, 3, 10 and 12 provides fluorescent validation plate 20 with the capability of evaluating the ability of an instrument to accurately and precisely measure a standard intensity and it allows for determination of instrument bias—the ability of the instrument being calibrated to measure intensity uniformly across an array of wells 32 of plate 20.

It may also be desired to evaluate the ability of an instrument to measure a range of intensities. This is accomplished in a preferred embodiment, for example, by including different intensity validation materials in two or more wells. In the embodiment shown in FIG. 5, different intensity validation materials are placed in columns 4, 5 and 6. In addition to having known intensities that are different from each other, the different intensity validation materials associated with columns 4, 5 and 6 have intensities that are different from the “standard” intensity validation material located in columns 1, 3, 10 and 12. The different intensity validation materials will typically comprise a fluorescence validation material having a first fluorescent layer and a continuous or quasi-continuous light attenuating second layer. In column 4, the intensity validation material comprises a fluorescent layer 40 and a composite attenuating layer 43 comprising two layers of continuous attenuating material. In column 5, the intensity validation material comprises a fluorescent layer 40 and a second continuous attenuating material 43′. In column 6, the different intensity validation material comprises fluorescent layer 40 and a third continuous attenuating layer 43″ wherein the first, second and third continuous attenuating layers associated with columns 4, 5 and 6 are different. The combination of three different continuous attenuating layers with the same fluorescent or reflective layer allows the resulting intensity validation materials in each of columns 4, 5 and 6 for example, to emit light at different controlled intensities.

At least two wells including different intensity validation materials are necessary to evaluate the ability of an instrument to measure different known intensities. It is preferred, however that at least three and more preferably four wells or more are associated with different intensity validation materials wherein at least one well is associated with a standard intensity validation material. Most preferably four groups or columns of wells, instead of just four wells, will be associated with different intensity validation materials.

The range of useful different intensities chosen can vary widely depending on the range of intensities measurable by the instrument being calibrated. In a preferred embodiment of the present invention, an intensity validation material having a standard intensity is chosen and used in wells in columns 1, 3, 10 and 12. When measuring intensity variations, it is preferred that at least one well includes a different intensity validation material that has intensity of at least about ten times greater than and/or about ten times less that the intensity of the standard intensity validation material. It is more preferred that the validation plates of this invention include at least a first different intensity validation material having an known intensity at least ten times to one hundred times or more greater than the standard intensity validation material and second different intensity validation material that has a known intensity at least ten times to at least one hundred times or more less than the standard validation material. In the embodiment of the variation plates shown in FIG. 5, at least one column of wells will include the standard intensity validation material (e.g. 1, 3, 10 or 12), one column will include a first intensity validation material with a known intensity about 10 times greater than the standard intensity validation material, another column will include an intensity validation material having a known intensity about 10 times less than the standard intensity validation material and a fourth column will include an intensity validation material having a known intensity about 100 times less than the standard intensity validation material.

In the exemplary embodiment of FIG. 5 where the spectrally neutral attenuating layer is in both the excitation and emission light paths, the chosen attenuator is essentially twice as effective as measured by a spectrophotometer. Therefore when choosing a spectrally neutral attenuator to reduce the intensity one optical density unit (ten-fold), one must use an attenuator of approximately one half of an optical density unit (about three-fold reduction).

In yet another embodiment of this invention, the microwell validation plate 20 may include one or more wells that are non-fluorescent. Such wells are shown in columns 2 and 11 of microwell validation plate 20 of FIG. 5. Columns 2 and 11 include a material strip 51 (preferably transparent glass or plastic) that is non-fluorescent. Having at least one well that identifies the background allows for verification, during calibration, that the instrument is not measuring fluorescence in wells that do not contain fluorescent materials. A group of non-fluorescent wells is also valuable to determine the limit of detection of an instrument. The limit of detection is normally determined from the noise of replicate measurements of background. In use care must be taken to ensure the non-fluorescent wells stay non-fluorescent by avoiding contamination, principally from fingerprints and dust.

Wavelength Validation Materials

In addition to providing for the validation and/or calibration of intensity measurements, microwell validation plates 20 of this invention may include one or more wells that are devoted to the validation and calibration of wavelengths. Wavelength calibration relies on sharp wavelength transitions (peaks or edges) to define specific wavelengths. Typical fluorophores do not have sharp enough spectral features to be of use in validating or calibrating the wavelength accuracy, precision or spectral bandwidth of a spectrofluorometer. As with fluorescence intensity validation materials, the present invention provides wavelength validation materials through the combination of a first fluorescent or reflective layer 12 and a second, spectrally selective, layer 14. The spectrally selective layer transmits light with sharp peaks or edges creating a wavelength validation material with sharply defined excitation and/or emission spectra. Examples of spectrally selective materials include colored filter glass (e.g., Schott RG, OG, GG, BG, WG, KG and UG series glass), spectrophotometer wavelength calibration materials (e.g., holmium glass or solution, didymium glass, benzene solution or vapor, potassium dichromate solution), rare earth metal doped glass, etalons, thin reflecting and/or absorbing films such as metal (e.g., Al, Ag, Au) metal alloys, or dielectric films. Preferable materials are sold state, stable and continuous.

In a preferred embodiment of a microwell plate 20 shown in FIG. 5, columns 7, 8 and 9 include validation materials that are used for wavelength validation and calibration. In particular, Column 8, shown in cut-away in FIG. 4 and shown in FIGS. 5-6 is divided into two sections to provide a two different wavelength validation reference materials used as background references for the two different wavelength validation techniques described below.

Column 9 includes a wavelength validation material including a first layer comprising a fluorescent material. Indeed, the first layer in column 9 is strip 40. The validation material of Column 9 further includes a spectrally selective layer 56. In a preferred embodiment, the spectrally selective layer is a didymium or holmium filter strip 56 that is located in the excitation path before the fluorescent material, in the emission path after the fluorescent material, or both. Holmium and didymium glass are used as spectral calibration materials in spectrophotometers because of their stability and sharp spectral features. Generally rare earth metal doped glasses exhibit such features (didymium is a combination of neodymium and praseodymium and, in very old literature, samarium). The light that reaches the detector is the combination of the spectrum imposed by the spectrally selective material and the fluorescence emission spectrum of the fluorescent material. The original spectrum of the spectrally selective material is recovered by comparing (e.g., ratioing) the combination spectrum to that of the fluorescent material alone. The spectrum of the fluorescent material may be measured at the same time as the combination or may be known from previous measurement.

For the purpose of measuring the spectrum of the fluorescent layer alone at least a portion of column 8 contains a fluorescent material strip 40′. This strip is the same fluorescent material 40 used in column 9. An optional spectrally neutral attenuating layer portion may be added to the column 8 validation materials so that the optical density is similar to that of the spectrally selective layer of strip 56 near the wavelength features to be validated.

The present invention also provides for non-fluorescent wavelength validation materials as shown in column 7. Column 7 includes a wavelength validation material 52 comprising a first layer 53 that exhibits specular and/or diffuse reflection and a second layer 55 of spectrally selective filter material. The reflective layer 53 performs essentially the same function as the fluorescent layer of the previously described wavelength validation material or the fluorescence intensity validation material, except in this case layer 53 transfers the excitation light to the detection system rather than converting the excitation light to fluorescence emission. Preferably the reflective layer exhibits primarily diffuse reflection of the excitation light because this type of reflection recreates the approximate spatial light pattern of fluorescence emission (i.e., fluorescence emission is essentially the same in all directions and so is diffuse reflection). Thus a diffuse reflective layer better simulates the fluorescence emission that a fluorometer is designed to collect.

In operation a reflective wavelength validation material is used in a manner similar to the fluorescent wavelength validation material. In a preferred embodiment the reflective layer is a frosted lower surface 53 of strip 52. As with the fluorescent layer the reflective layer may be the lower surface of the spectrally selective layer, may be applied or attached to it, or the reflective layer may be embodied in a separate material layer that is affixed or held in proximity to the spectrally selective layer. In column 7 the spectrally selective material layer is a didymium or holmium filter strip 55 that is located in the excitation path before the reflective layer or in the emission path after the reflective layer or both. The light that reaches the detector is the combination of the spectrum imposed by the spectrally selective material and the reflected excitation light spectrum. The original spectrum of the spectrally selective material is recovered by comparing (e.g., ratioing) the combination spectrum to that of the reflective layer alone. The reflected excitation light spectrum may be measured at the same time as the combination or may be known from previous measurement. The reflected excitation light spectrum is itself a combination of the excitation light spectrum (which is preferably very broad for this use) and the reflective layer spectrum (preferably neutral).

For the purpose of measuring the spectrum of the reflective layer alone column 8 contains a wavelength validation material 54 consisting of a strip 57 with a reflective layer 53. This is the same reflective layer 53 as applied to the underside of strip 52 but the material 57 that is the second layer is spectrally neutral. Preferably the spectrally neutral layer is chosen so that the optical density is similar to that of the spectrally selective layer 55 near the wavelength features to be validated.

Both fluorescence and reflectance wavelength calibration techniques have similar accuracy and precision, but the wavelength ranges are different depending on the type of instrument. For example, the fluorescence technique only functions with wavelengths that are within the excitation and emission spectra of the underlying fluorescent material. The reflectance technique is only useful in the wavelength region where both the excitation and emission optical systems are capable of transmitting light.

Polarization Validation Materials

In another embodiment of this invention, the fluorescence validation material 10 of this invention may be used as fluorescence polarization standards. As mentioned above, the fluorescent polarization validation materials of this invention are useful for evaluating the calibration of instruments that measure fluorescence polarization. In another embodiment, the polarization validation material can be used in microwell plate reader validation and calibration.

Certification

The fluorescent validation materials and plates of this invention are useful for validating and/or calibrating instruments such as fluorometers. Before they are used for calibration and validation, the microwell validation plates of this invention must first be certified. The certification process includes formulating identifying information about each validation plate using a certification instrument.

The certification instrument must be calibrated or validated (verified as calibrated) before use to certify validation plates. Generally the certification instrument is an instrument that is similar to or the same as the instrument which is intended to be validated with the certified validation plate. This ensures that the certification instrument can identify accurate and useful intensity, wavelength and/or polarization information about each validation plate. The concern to use a similar certification instrument is especially important when the instrument was not specifically designed to measure samples of the validation materials of this invention. For example most microwell plate readers are designed to measure liquid samples held in a microwell plate. Some embodiments of this invention are solid samples formed to the dimensions of a microplate. The subtle differences between solid and liquid samples can affect the measurement of the sample. Such differences include the shape of the sample interface (meniscus), height of the sample interface, index of refraction of the sample, and optical density of the sample.

The certification process is described for a fluorometer. However, the certification procedure can be easily applied by persons of ordinary skill in the art to certify validation plates useful for other similar instruments.

Intensity Certification

In a preferred method, the certification instrument is calibrated or validated using microwell plates including wells holding solutions with known precise amounts of fluorophore (e.g., fluorescein, rhodamine, quinine sulfate). For example a standard solution of 100 nM fluorescein can be used to calibrate or validate the intensity and/or polarization of the certification instrument. The intensity from the fluorescent standard solution can be used to set the intensity scale of the certification instrument—relative fluorescence units (RFU) are indicated relative to the measured intensity of this standard solution. The scale may be set by recording the measured intensity of the standard solution and ratioing all future intensities to this value or by adjusting the certification instrument's RFU scale with a correction factor so that the standard solution yields a defined intensity (e.g., 2000 RFU). Alternatively the light source intensity or detector gain may be adjusted to achieve the desired RFU value. Any correction to the measured intensity is expected to be wavelength dependent so ideally the standard solution is measured and the instrument calibrated at multiple wavelengths across the range of the certification instrument. Because intensity measurement is wavelength dependent, the certification instrument must already be validated for wavelength accuracy before performing any intensity validation or calibration.

The calibration of the certification instrument may also be checked for linearity with solutions of known higher and/or lower concentrations e.g., 1000, 100, 10 and 1 nM fluorescein solutions. However linearity is a relative performance metric and so does not strictly require a standard solution only that the samples tested have a known intensity ratio. Alternatively linearity may be calibrated or validated using intensity validation materials of the present invention constructed with certified attenuating filters. The attenuating material can be certified with a spectrophotometer certified independently in the conventional manner (e.g., via NIST traceable materials). It is preferred that maximum allowable deviation from linearity (ratio of measured to expected value) is small, the value being instrument dependent (for example 5% for the brightest solutions and 2% for the dimmest). The certification instrument may also be calibrated for linearity by adjusting the reported RFU value in an intensity dependent manner. This transfer function translates the measured values into linear reported values. The calibration function is typically a polynomial or spline fit based upon the measured values of the known samples.

Wavelength Certification

The certification instrument may be validated or calibrated for wavelength accuracy, precision and/or spectral bandwidth using a wavelength validation material constructed with a certified spectrally selected material. The spectrally selected material can be certified with a spectrophotometer certified independently in the conventional manner (e.g., via NIST traceable materials). Alternatively one may use other wavelength standards with sharp spectral features, such as fluorescent materials (e.g. aromatic hydrocarbons or lanthanides) and lamps (e.g., mercury arc, xenon arc).

Wavelength accuracy is determined by measuring the wavelength validation material and comparing to the known spectra of the material. If an independently certified wavelength validation material of this invention is used to validate or calibrate the certification instrument the spectra of the wavelength validation material are compared to the spectra of the underlying fluorescent or reflective layer. The ratio of the spectra is the apparent spectrally selective layer spectra. Peaks or edges in the apparent spectra should be the same in the certification instrument as that known from the independent (spectrophotometric) certified measurement. Some corrections may be necessary due to the finite bandwidth of the certification instrument. First the spectral bandwidth of the spectrophotometer may be different than that of the certification instrument. If they are different the spectral feature of interest may be significantly shifted. For example narrow peaks of the didymium glass spectrum are shifted by several nanometers when measuring in a wide bandwidth instrument as compared to a narrow one. In a similar way, background (fluorescence or reflectance) spectra that is not neutral near the spectral feature can distort the measured spectra in the certification instrument, even after ratioing the background to arrive at the apparent spectra. These phenomena are known in the art as exemplified by Venable and Eckerle (1979) “Standard reference materials: Didymium glass filters for calibrating the wavelength scale of spectrophotometers—SRM 2009, 2010, 2013 and 2014”, Natl. Bureau of Standards Special Publication 260-66, incorporated herein by reference.

The difference, after correction for measurement conditions, of the measured and the known spectra are then compared to the accuracy tolerance of the certification instrument to determine if the instrument is within calibration. If it is not within tolerance the difference may be used to adjust the wavelength tuning device (e.g., monochromator) of the certification instrument. This adjustment may be mechanical, electronic or in software. The adjustment corrects for command position versus actual position via a transfer function that may be, for example, linear, polynomial, or spline fit. If no adjustment is possible the instrument must be repaired.

Wavelength precision is best measured by repeatedly measuring the intensity along a spectral edge of the wavelength validation material. If the wavelength is imprecise the intensity will vary according to the slope of the spectral edge. The precision is compared to the tolerable precision of the certification instrument. If the precision is within tolerance the certification instrument is validated. If not there is a likely failure of a component of the instrument and it must be repaired. There is not typically a calibration mechanism for precision.

Spectral bandwidth is also measurable with a wavelength validation material. The bandwidth can be measured by determining peak locations as described above but a more sensitive manner is to measure the peak width of a narrow peak in the validation material spectrum. The width of the peak is directly related to the spectral bandwidth of the certification instrument. As with all validation if the measured bandwidth is within tolerance the certification instrument is validated. If not the spectral bandwidth tuning device, e.g. slit, of the certification instrument may be adjusted. The adjustment may be through means like those for wavelength accuracy.

Polarization Certification

The certification instrument may be validated or calibrated for polarization accuracy with a polarization validation material that has been certified within a fluorescence polarimeter that can measure absolute polarization, for example an L- or T-format cuvette based instrument. Alternatively the certification instrument may be validated or calibrated for polarization accuracy with a polarization standard, a composition of known polarization value as found in scientific literature or measured on an absolute fluorescence polarimeter.

Polarization accuracy of the certification instrument is validated or calibrated similar to intensity and wavelength. A standard material of known polarization is measured and the measured value is compared to the known value. Polarization is measured by collecting the emission light parallel and perpendicular to the excitation light. Any imbalance in the certification instrument response to these two polarization states will skew the accuracy. Measuring a known polarization (known parallel to perpendicular ratio) allows the instrument imbalance to be quantified. The ratio of the known parallel to perpendicular ratio to the measured one is the polarization correction factor (often referred to as the g-factor). The correction factor must be within tolerance (e.g., unity +/−2%) or used to correct the measured value to the known value (i.e. all measured values are multiplied by the correction factor). The polarization correction factor, like the intensity, is wavelength dependent and ideally should be measured at a range of wavelengths comparable to the range of the certification instrument. Polarization validation or calibration, also like intensity, must be performed after wavelength validation or calibration to ensure valid results.

Plate Certification

Before the validation plates are considered ready, they must be certified. Before the validation plates of this invention are assembled, the strips of fluorescent materials used as the first material layer 12 of the validation materials of this invention are prescreened for fluorescence uniformity in a certification instrument. Two critical measurements are the intensity CV (coefficient of variation, the standard deviation divided by the average) within a strip and the combined CV of the four strips used for the reference intensity (in columns 1,3,10, and 12 of the finished plate). These four strips are matched more stringently because they will be used as the primary measure of an instrument's accuracy, precision and bias. Once the material is qualified, it is assembled in a validation plate and the assembled plate is certified as described above.

The validation plates used by instrument users are certified using the certification instrument. The plate is certified for intensity, wavelength and polarization calibration by certain criteria. The criteria used to certify validation plates will vary depending upon the instrument type as well as the design range, precision and accuracy of the instrument. For example the wavelength accuracy and precision of must be within 1 nm; the intensity CV of all wells within each strip must be less than 0.5%; the intensity CV of all standard intensity wells (four strips) must be less than 0.5%; the polarization standard deviation of each strip must be less than 3 mP.

Generally it is desirable to average the intensity, wavelength or polarization readings associated from all wells of the same material (a single column in this example). The average reading, at least for intensity linearity purposes, is compared with average readings of wells associated with intensity validation materials having known intensities greater or less than the standard validation material intensities. Thus, the wells that include the standard intensities validation materials are read by the calibration instrument and the average values for each column are recorded for each validation plate.

If each of the certification criteria is met, then the validation plate is certified and data concerning the validation plate such as the certified intensities and wavelength peaks are recorded. If the criteria are not met the validation materials may have to be discarded, cleaned or reassembled in a different combination and the new plate tested for certification.

Once a validation plate is certified in a certification instrument the certified plate may be used as a standard to certify other instruments. Certified validation plates may be used to periodically confirm that any certification instrument is operating within proper parameters.

Validating Fluorescence Readers

Methods of using the certified validation plate are fairly simple. A validation plate in placed in an instrument to analyze each of the plurality of plate wells. The instrument results are reported electronically, they are printed or they are proved by some other means. The results of specific operations are compared to the certified performance of the validation plate. The instrument under test is validated if its performance meets the certified criteria within tolerance. If an instrument is not within tolerance, manual hardware or software or automatic adjustment may be possible and the instrument retested to verify performance. Alternatively the lack of performance may represent a failure that would require service by the manufacturer.

The certification of the validation plate is generally only valid for a limited period (e.g., one year). When the certification expires the plate must be recertified to ensure the plate's performance. The recertification process may consist of the same process as certification or may consist of a verification step in a calibrated fluorescence reader followed by an optional certification step.

Certified validation plates of this invention comprising at least one fluorescent validation material, including, but not limited to the microwell validation plates of this invention allow for the validation of many instrument performance parameters including those selected from the group consisting of (a) intensity (Relative Fluorescent Units, RFU) scale calibration; (b) intensity precision and bias; (c) wavelength accuracy, precision, spectral bandwidth and bias; (d) sensitivity; (e) linear dynamic range; and (f) polarization accuracy, precision and bias. Such capabilities have become extremely important to instrument users. These performance parameters are validated and calibrated the same way as described for the certification instrument except that the certified validation plate is used instead of any other standard materials.

As most microwell plate readers are designed to measure liquid samples, use of the validation plate of this invention may require some reader adjustment for the solid state validation materials. These materials differ from liquid samples generally by possessing a higher index of refraction (yielding higher reflection from surface and more beam steering within the sample) and a flat upper surface (yielding less beam steering from the surface). The first optical surface of validation materials of this invention could be coated to reduce unwanted reflection as is standard in the art and could be formed to mimic the meniscus of liquid samples. The higher index of refraction of the validation materials may require optimization of the beam position within the sample for some microwell plate readers, particularly those which employ light that does not enter the sample perpendicular to the microwell plate. In these cases the mechanical center of the well will not be the optical center of the well. This difference may be significant (1 mm in a 6 mm diameter well) and can be determined for example by measuring the fluorescence intensity at several positions within the well calculate the peak intensity. In this case the reader would need to adjust the well positions appropriately to properly measure the validation plate.

From the foregoing it will be appreciated that, although specific embodiments of the invention have been described herein for purposes of illustration, various modifications may be made without deviating from the spirit and scope of the invention.

1. A fluorescence validation material comprising:
a first layer selected from a fluorescent layer or a reflective layer; and
a second light attenuating layer selected from a continuous attenuating layer or a quasi-continuous attenuating layer.

2. The fluorescence validation material of claim 1 wherein the first layer is fluorescent.

3. The fluorescence validation material of claim 2 wherein the first fluorescent layer comprises a stable fluorescent material.

4. The fluorescence validation material of claim 3 wherein the stable fluorescent material is temperature stable.

5. The fluorescence validation material of claim 3 wherein the stable fluorescent material is photostable.

6. The fluorescence validation material of claim 1 wherein the first layer is a solid material layer.

7. The fluorescence validation material of claim 6 wherein the solid material is a fluorescent material loaded polymer.

8. The fluorescence validation material of claim 7 wherein the polymer is selected from the group consisting of acrylic polymers, phenoxy polymers, polycarbonate polymers, polyvinylchloride polymers, and combinations thereof.

9. The fluorescent validation material of claim 8 wherein the polymer is an acrylic polymer.

10. The fluorescence validation material of claim 6 wherein the solid material is a fluorescent acrylic polymer.

11. The fluorescence validation material of claim 10 wherein the second light attenuating layer is a neutral density glass.

12. The fluorescence validation material of claim 10 wherein the second light attenuating layer is a Didymium glass.

13. The fluorescence validation material of claim 1 wherein the first material is a reflective layer.

14. The fluorescence validation material of claim 1 wherein the second light attenuating layer is spectrally neutral or spectrally selective.

15. The fluorescence validation material of claim 14 wherein the second light attenuating layer is a spectrally selective layer including a material selected from the group consisting of metal-doped glasses, dielectric films, etalons, inks, colored glass and combinations thereof.

16. The fluorescence validation material of claim 15 wherein the spectrally selective material is a glass that is doped with a rare earth metal selected from the group Holmium, Neodymium, Praseodymium, Samarium, and combinations thereof.

17. The fluorescence validation material of claim 14 wherein the second light attenuating layer is neutral density glass.

18. The fluorescence validation material of claim 14 wherein the second light attenuating layer is didymium glass.

19. The fluorescence validation material of claim 1 wherein the second light attenuating layer has a polarization neutral or polarization selective attenuation.

20. The fluorescence validation material of claim 19 wherein the second light attenuating layer is a polarization attenuating material.

21. The fluorescence validation material of claim 19 wherein the second light attenuating layer is a light scattering material

22. The fluorescence validation material of claim 19 wherein the second light attenuating layer is a dichroic polarizer.

23. The fluorescence validation material of claim 1 wherein the second light attenuating is a quasi-continuous attenuating layer comprising a micro-patterned material.

24. The fluorescence validation material of claim 22 wherein the micro-patterned material is selected from the group consisting of a fine wire mesh, absorbing inks, reflective inks, metals, and combinations thereof.

25. The fluorescence validation material of claim 1 wherein the first layer and the second light attenuating layer contact one another.

26. The fluorescence validation material of claim 25 wherein the first layer and the second light attenuating layer are adhered to one another.

27. The fluorescence validation material of claim 1 wherein a gap separates the first layer and the second light attenuating layer.

28. The fluorescence validation material of claim 1 wherein the second light attenuating layer is essentially non-fluorescent.

29. A microwell plate including a plurality of wells wherein at least one well includes a fluorescence validation material of claim 1.

30. A microwell plate comprising a plurality of wells wherein at least two wells include different fluorescence validation materials and wherein the fluorescence validation materials are selected from:
an intensity validation material;
a wavelength validation material; and
a polarization validation material.

31. The microwell validation plate of claim 30 wherein the validation material comprises a first layer that is a fluorescent or reflective layer and a second light attenuating layer that is a continuous layer or a quasi-continuous layer.

32. The microwell validation plate of claim 30 wherein each fluorescence validation material comprises a first fluorescence or reflective layer and a second continuous or quasi-continuous attenuating layer.

33. The microwell validation plate of claim 30 wherein the intensity validation material further comprises a first layer of fluorescent or reflective material and a second light attenuating layer that is spectrally neutral and polarization neutral.

34. The microwell validation plate of claim 30 wherein the wavelength validation material further comprises a first layer of fluorescent or reflective material and a second light attenuating layer that is spectrally selective and polarization neutral.

35. The microwell validation plate of claim 30 wherein the polarization validation material further comprises a first layer of fluorescent or reflective material and a second light attenuating layer that is spectrally neutral and polarization selective.

36. A microwell validation plate comprising:
a carrier having a plurality of wells arranged in an array including at least one row of wells and at least one column of wells; and
at least two wells that include different fluorescence validation materials wherein the validation material comprises a first layer that is a fluorescent or reflective layer and a second light attenuating layer that is a continuous layer or a quasi-continuous layer and wherein the validation material is selected from:
(i) an intensity validation material including a first layer of fluorescent or reflective material and a second light attenuating layer that is spectrally neutral and polarization neutral;
(ii) a wavelength validation material including a first layer of fluorescent or reflective material and a second light attenuating layer that is spectrally selective and polarization neutral; and
(iii) a polarization validation material including a first layer of fluorescent or reflective material and a second light attenuating layer that is spectrally neutral and polarization selective.

37. The microwell validation plate of claim 36 including two or more wells containing essentially the same validation material.

38. The microwell validation plate of claim 37 wherein the essentially the same validation material is an intensity validation material that is located in all of the wells of at least one column.

39. The microwell validation plate of claim 37 wherein the essentially the same validation material is an intensity validation material that is located in wells in at least two non-adjacent columns.

40. The microwell validation plate of claim 37 wherein the essentially same type of validation material is an intensity validation material and wherein the essentially same type of intensity validation material is located in wells in opposing rows or opposing columns.

41. The microwell validation plate of claim 36 including a first intensity validation materials are located a first well and a second intensity validation material located in a second well wherein the first and second intensity validation materials fluoresce at different intensities.

42. The microwell validation plate of claim 36 wherein at least one well includes an intensity validation material and at least one well includes a wavelength validation material.

43. The microwell validation plate of claim 42 including an intensity validation material in a first well and a wavelength validation material in the second well and wherein the intensity validation material and the wavelength validation material each including the same first fluorescent or reflective material layer.

44. The microwell validation plate of claim 36 including at least one well that is essentially non-fluorescent.

45. The microwell validation plate of claim 36 including an intensity validation material located in a first well, a wavelength validation material located in a second well and a polarization validation material located in a third well.

46. The microwell validation plate of claim 36 wherein at least one well includes an intensity validation material that is a standard intensity validation material having a known intensity, wherein at least one well includes a first different intensity validation material having a known intensity that is greater than the known intensity of the standard intensity validation material and wherein at least one well includes a second different intensity validation material having a known intensity that is less than the known intensity of the standard intensity validation material.

47. The microwell validation plate of claim 46 wherein the first different intensity validation material has a known intensity at least 10 times greater than the known intensity of the standard intensity calibration material.

48. The microwell validation plate of claim 46 wherein the first different intensity validation material has a known intensity at least 100 times greater than the known intensity of the standard intensity calibration material.

49. The microwell validation plate of claim 46 wherein the second different intensity validation material has a known intensity at least 10 times less than the known intensity of the standard intensity calibration material.

50. The microwell validation plate of claim 46 wherein the second different intensity validation material has a known intensity at least 100 times less than the known intensity of the standard intensity calibration material.

51. The microwell validation plate of claim 46 wherein at least one well includes a third different intensity validation material having a known intensity that is less than the known intensity of the standard intensity validation material and that is less than the known intensity of the second different intensity validation material.

52. The microwell validation plate of claim 36 including at least one well associated with a first wavelength validation material and a second well associated with a second wavelength validation material.

53. The microwell validation plate of claim 36 including at least one well associated with a standard intensity validation material, and at least one well associated with a first different intensity validation material.

54. The microwell validation plate of claim 53 further including at least one well associated with a second different validation material wherein the first different validation material has a known intensity less than a known intensity of the standard validation material.

55. The microwell validation plate of claim 54 further including a first wavelength validation material and a second wavelength validation material.

56. The microwell validation plate of claim 36 including an intensity validation material in a first well, a wavelength validation material in a second well and a polarization validation material in a third well.

57. A microwell validation plate comprising a carrier having a plurality of wells arranged in an array of a plurality of rows and a plurality of columns wherein at least one column includes a well associated with a standard intensity validation material, at least one column includes a well associated with a first different intensity validation material, at least one column includes a well associated with a second different intensity validation material, at least one column includes a well that is associated with a third different intensity validation material, at least one column includes a well associated with a first wavelength validation material, and at least one column includes a well associated with a second wavelength validation material.

58. The validation plate of claim 57 wherein from 2 to 6 columns each include at least one well associated with the standard intensity validation material.

59. The validation plate of claim 58 wherein the first and the last column in the array include at least one well associated with the standard intensity validation material.

60. A method for calibrating an instrument comprising the steps of:
preparing a validation plate comprising a carrier having a plurality of wells arranged in an array including at least one row of wells and at least one column of wells wherein at least one well contains a fluorescence validation material selected from an intensity validation material having a first layer and a second light attenuating layer selected from a continuous attenuating layer and a quasi-continuous attenuating layer, a polarization validation material, and a wavelength validation material wherein the fluorescence validation material emits light having at least one feature having a known value when an excitation source is directed at the validation plate;
placing the validation plate in an instrument that includes a excitation source and a detector;
directing the excitation source at the validation plate;
detecting a value for the at least one feature of the light being emitted from at least one well; and
comparing the detected value of the light feature emitted from the at least one well with the known value of the light feature.

61. The method of claim 60 wherein the light feature that is evaluated is selected from an intensity feature, a wavelength feature, a polarization feature and combinations thereof.

62. The method of claim 61 wherein the comparing step determines an instrument feature selected from the group consisting of relative fluorescence units, intensity precision, instrument bias, wavelength accuracy, wavelength precision, dynamic range, polarization accuracy, polarization precision and any combinations thereof.

63. The method of claim 62 wherein the evaluated light feature is both an intensity light feature and a wavelength light feature.

64. The method of claim 60 wherein the validation plate includes at least one well including a wavelength validation material and at least one well that includes an intensity validation material.

65. The method of claim 60 wherein the evaluated light feature is a wavelength feature.

66. The method of claim 65 wherein the comparing step determines a instrument feature selected from wavelength accuracy, wavelength precision and combinations thereof.

67. The method of claim 61 wherein the evaluated light feature is a polarization feature.

68. The method of claim 61 wherein the evaluated light feature is a polarization feature and at least one second evaluated light feature selected from an intensity feature and a wavelength feature.

69. The method of claim 60 wherein the validation plate is certified by the further steps of:
(i) placing the validation plate in a certified machine that includes an excitation source and a detector;
(ii) directing the excitation source at the validation plate;
(iii) detecting a value for the at least one feature of the light being emitted from at least one well; and
(iv) comparing the detected value of the light feature emitted from the at least one well with the expected value of the light feature; and
(v) certifying the validation plate if the detected value of the light feature is within specification.

70. The method of claim 69 wherein the certification occurs before the validation plate is used to calibrate the instrument being calibrated.
